(19) United States
(12) Patent Application Publication
(10) Pub. No.: US 2011/0050718 A1
(43) Pub. Date: Mar. 3, 2011

(54) METHOD FOR COLOR ENHANCEMENT

(75) Inventor: Jian-Feng Wang, Shenzhen City (CN)

(73) Assignees: INNOCOM TECHNOLOGY (SHENZHEN) CO., LTD., Shenzhen City (CN); INNOLUX DISPLAY CORP., Miao-Li County (TW)

(21) Appl. No.: 12/700,930

(22) Filed: Feb. 5, 2010

(30) Foreign Application Priority Data
Aug. 26, 2009 (CN) 200910306127.5

(51) Int. Cl. G09G 5/02

(52) U.S. Cl. 345/589

(57) ABSTRACT

A color enhancement method for a display device includes obtaining color information of a first display frame from the display, determining a dominant color according to the color information obtained, and color enhancing a second display frame following the first display frame by adjusting the second display frame according to the dominant color. The dominant color is obtained by analyzing the preceding display frame and dynamically enhancing the second display frame.

### BACKGROUND

1. Technical Field

The present disclosure relates to a method for color enhancement for a display device.

2. Description of the Related Art

A display device used in a computer generally includes several display picture modes such as video mode, photo mode, scenery mode, internet mode, and game mode etc., for displaying images under different viewing requirements. The display device enhances a predetermined color under each display mode. For example, skin color is enhanced selectively under the photo mode, and green color is enhanced selectively under the scenery mode. A user may set a proper display picture mode according to the working status, to have a better view than the original view. The user must be knowledgeable ahead of time as to the required visual effects desired to be accomplished and also familiar with all of the display picture modes so as to set a proper display mode during use.

However, the above conventional method of color enhancement is static, thus the enhanced color remain unchanged when the display picture mode has been set. The image displayed may have variable picture mode requirements therein, therefore, in this situation, the static color enhancement may be improper. For example, the green color is selectively enhanced during the scenery mode, but when the scenery is switched to white snow or blue sky, the existing color enhancement is then improper.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views, and both the views are schematic.

FIG. 1 is a flowchart of a method for color enhancement.

FIG. 2 is a color gamut distribution view of six color zones in a color space.

FIG. 3 is a lookup table showing the corresponding color gamut range of each color zone of FIG. 2, and the selected color for enhancement in each color zone.

### DETAILED DESCRIPTION

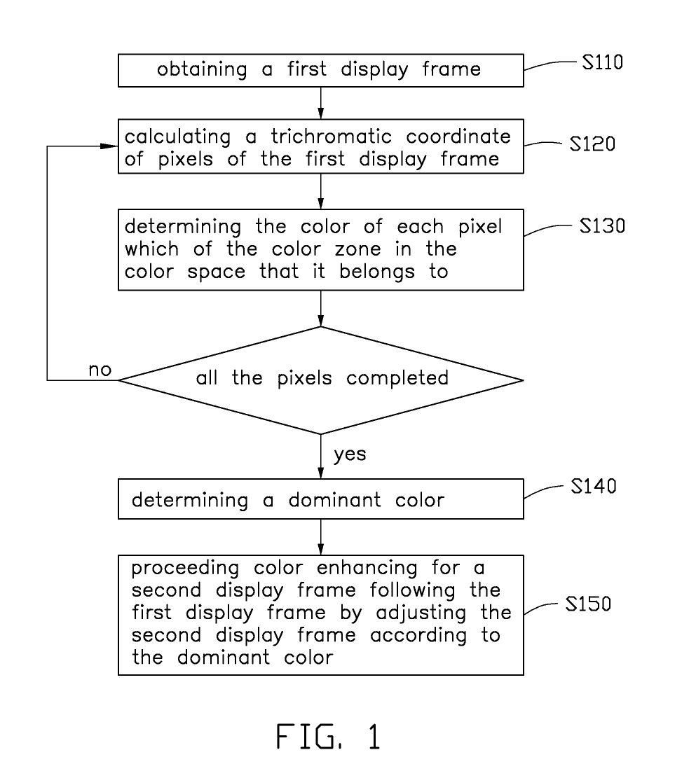

Referring to FIG. 1, a method for color enhancement may be used in a display device. A color image output from a data source, such as a computer, may be modified using the method and displayed on the display device. The method for color enhancement includes steps as follows.

In step 110, a first display frame is obtained from the display device. The display frames are continuously outputted by the display device with a frequency of 30 Hz or 60 Hz, for example, forming a continuous frame stream. In this step, sequential sampling may be used to obtain the first display frame (present frame), and to go through a set of calculations to obtain the subsequent next frame (next frame), and every frame presented can be selected as the first display frame in turn or periodic sampling may be used to obtain the first display frame instead, and the frames presented are selected as the first frame at a predetermined interval. For example, in a continuous frame stream I1, I2, I3, I4, I5 . . . , the first display frame can be I1, I2, I3, I4, I5 . . . in turn under sequential sampling, or the first display frame can be I1, I3, I5 . . . , or I2, I4, I6 . . . , or even I1, I4, I7 . . . under periodic sampling. The first display frame has a plurality of pixels distributed in rows, and each pixel has one individual color value of three primary colors red, green and blue.

In step 120, a trichromatic coordinate of the pixel of the first display frame in the CIE (Commission International d'Eclairage) 1931 chroma space is calculated. In other embodiments, the trichromatic coordinate of the pixel may be calculated in CIE LUV, CIE 1964 UVW or CIE LAB color space. The trichromatic coordinate of the pixel may be calculated by the following equations:

r=R/(R+G+B), (1)

g=G/(R+G+B), (2)

b=B/(R+G+B) (3)

or:

x=(0.490r+0.310g+0.200b)/(0.667r+1.132g+1.200b), (4)

y=(0.117r+0.812g+0.010b)/(0.667r+1.132g+1.200b). (5)

Wherein R, G, B are the primary color values of the pixel; and x, y are the trichromatic coordinates of the pixel.

All the rows of pixels in the first display frame may be selected and calculated, or pixel rows may be selected via interlaced sampling at the same interval and the trichromatic coordinate of the pixels calculated. As a result, the “betweenframe” sampling method of step 110 combined with the “in-frame” sampling method disclosed in this step can provide improved implementation flexibility.

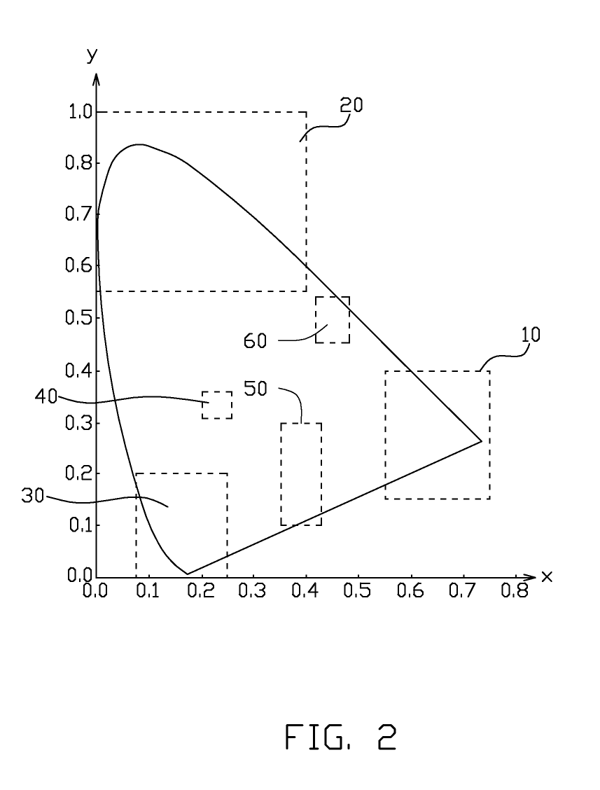

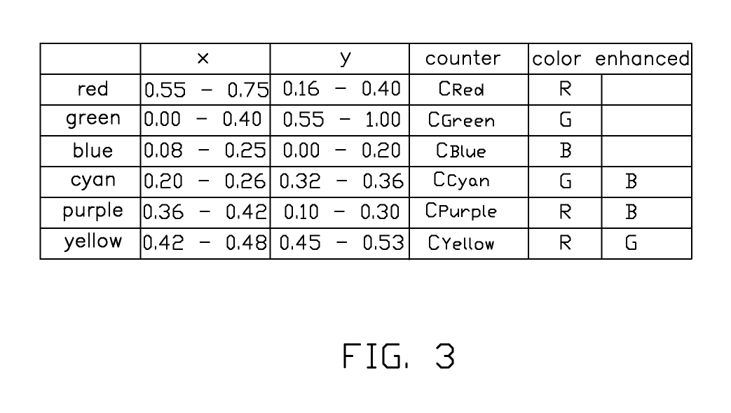

In step 130, the color of each pixel as to see which of the color zone in the color space that it belongs to is determined. Referring to FIGS. 2 and 3, six color zones: a red zone 10, a green zone 20, a blue zone 30, a cyan zone 40, a purple zone 50 and a yellow zone 60 are defined in the CIE 1931 chroma space. FIG. 3 shows the color range of each color zone. The display device includes six counters CRed, CGreen, CBlue, CCyan, Cpurple and CYellow (not shown) in a chip (not shown) for the six color zones, respectively. For example, if a trichromatic coordinate (x,y) of a pixel in the first display frame is (0.6,0.3), it is in the red zone 10 according to FIG. 3, therefore, a counter of the red CRed adds a count of one. If all the pixels selected are counted by the counters respectively, go to the next step; if not, go back to step 120, such that each pixel gets an individual counter value therein finally.

In step 140, a dominant color according to the counter value totals of each color zone is determined. The dominant color may be determined by one of the three rules below. First rule: if a color has a counter value equal to or greater than a total sum of the counter values for all of the other colors, that color is then chosen as a dominant color. Second rule: if a color has a counter value greater than 20% of the total sum of all the counter values of all colors (and including the counter value of the color itself), that color is chosen as a dominant color. Third rule: if a color has a counter value greater than that of any counter value of each of the other colors, that color is chosen as a dominant color. In another embodiment, the dominant color may be determined by the second rule and the third rule cooperatively.

In step 150, the color of a second display frame following the first frame is enhanced according to the dominant color. If the dominant color in the step 140 is a primary color, for example, the dominant color is red, then a pixel in the second frame has the R, G, B values (200, 15, 15), and the corresponding trichromatic coordinate of the pixel is (0.627, 0.212). Referring to FIG. 3, the corresponding trichromatic coordinate of the pixel is found to be located in the red zone 10, and that red is a primary color, then the display device enhances the R value of the pixel, which is 200 in this example, by 20% before the second frame is displayed on the display device. That is, the R, G, B value of the pixel displayed on the display device is enhanced to (240, 15, 15). If the dominant color is not a primary color, for example, the dominant color is cyan, a pixel of the second display frame with R, G, B values (0, 240, 240), thus the trichromatic coordinate of the pixel is (0.219, 0.352). Referring to FIG. 3, the corresponding trichromatic coordinate of the pixel is found to be located in the cyan zone 40. The display device increases the green color value and the blue color value by 20% (upper limit value is 255) as enhancement. That is, the R, G, B value of the pixel of the second display frame displayed on the display device is enhanced to (0,255,255). In another example, if the dominant color is a primary color other than cyan, and a pixel of the following second display frame is not located in the primary color zone (for example, cyan, purple and yellow), the pixel is then not color enhanced in the display device.

In the above embodiments, the first display frame is selected and analyzed in the method for color enhancement, and then a dominant color is determined. The second display frame is then enhanced according to the dominant color, such that the second display frame can be dynamically color enhanced.

Finally, while particular embodiments have been described, the description is illustrative and is not to be construed as limiting. For example, various modifications can be made to the embodiments by those of ordinary skill in the art without departing from the true spirit and scope of the invention as defined by the appended claims.

What is claimed is:

1. A method for color enhancement in a display device comprising:
obtaining color information of a first display frame of the display device;
determining a dominant color according to the color information of the first display frame; and
color enhancing a second display frame following the first display frame by adjusting the second display frame according to the dominant color.

2. The method for color enhancement of claim 1, wherein a trichromatic coordinate of each pixel in the first display frame is calculated to obtain the color information.

3. The method for color enhancement of claim 2, further comprising: defining a plurality of color zones in a color space, and counting pixels of the first display frame located in each color zone.

4. The method for color enhancement of claim 3, wherein the color space defines a red zone, a green zone, a blue zone, a cyan zone, a purple zone and a yellow zone.

5. The method for color enhancement of claim 3, wherein the color space is CIE 1931 XYZ color space, CIE LUV color space, CIE 1964 UVW color space, or CIELAB color space.

6. The method for color enhancement of claim 3, further comprising: counting the pixels located in each color zone by a counter in a chip.

7. The method for color enhancement of claim 1, wherein the first display frame is obtained in a continuous frame stream by periodic sampling.

8. The method for color enhancement of claim 1, wherein the color information is obtained in all pixels of the first display frame.

9. The method for color enhancement of claim 1, wherein the color information is obtained in the rows of pixels with the same interval in the first display frame.

10. The method for color enhancement of claim 6, wherein the dominant color is determined by the color zone having a counter value greater than a total sum of counter values located in all other color zones.

11. The method for color enhancement of claim 6, wherein the dominant color is determined by the color zone having a counter value greater than 20% of a total sum of all the counter values in all color zones.

12. The method for color enhancement of claim 6, wherein the dominant color is determined by the color zone having the highest counter value among all of the color zones.

13. The method for color enhancement of claim 3, wherein a primary color value of a pixel located in the color zone corresponding to the dominant color in the second display frame is increased 20% according to the dominant color before the second frame is displayed on the display device.

14. A method for color enhancement in a display device comprising:
obtaining a first display frame of the display device;
calculating a trichromatic coordinate of a pixel of the first display frame;
providing a color space defining a plurality of color zones;
counting the pixels located in each color zone;
determining a dominant color according to the pixel counter value totals of each color zone; and
enhancing pixels with the same color as the dominant color in a second display frame following the first display frame according to the dominant color.

15. The method for color enhancement of claim 14, further comprising defining a plurality of color zones in a color space, and counting pixel of the first display frame located in each color zone.

16. The method for color enhancement of claim 15, wherein a primary color value of a pixel located in the color zone corresponding to the dominant color in the second display frame is increased 20% according to the dominant color before the second frame is displayed on the display device.
